(19) United States
(12) Patent Application Publication
(10) Pub. No.: US 2026/0360025 A1
(43) Pub. Date: Nov. 12, 2026

(54) IN-CONTEXT INFERENCE TIME SCALING FOR IMAGE GENERATION AND EDITING

(71) Applicant: QUALCOMM Incorporated, San Diego, CA (US)

(72) Inventors: Shreya Kadambi, San Diego, CA (US); Risheek Garrepalli, San Diego, CA (US); Shubhankar Mangesh Borse, San Diego, CA (US); Munawar Hayat, San Diego, CA (US); Fatih Murat Porikli, San Diego, CA (US)

(21) Appl. No.: 19/359,000

(22) Filed: Oct. 15, 2025

Related U.S. Application Data
(60) Provisional application No. 63/803,255, filed on May 9, 2025.

(51) Int. Cl. G06T 11/00; G06F 16/532

(52) U.S. Cl. CPC G06T 11/00; G06F 16/532

(57) ABSTRACT

An example device for generating image data includes a processing system configured to receive an image and a prompt to modify the image, the prompt representing a complex revision task including sub-tasks to be issued to an artificial intelligence/machine learning (AI/ML) model configured to perform in-context image generation; generate sub-prompts from the prompt, each of the sub-prompts corresponding to a sub-task of the sub-tasks; generate a series of prompt tokens including a respective sub-series of prompt tokens for each of the sub-prompts, each of the sub-series of prompts being separated by a number of pause tokens, the pause tokens comprising tokens configured to cause the AI/ML model to increase a computational capacity when performing the complex revision task; and provide the image and the series of prompt tokens to the AI/ML model to cause the AI/ML model to generate a revised image according to the complex revision task.

This application claims the benefit of U.S. Provisional Application No. 63/803,255, filed May 9, 2025, the entire contents of which are hereby incorporated by reference.

### TECHNICAL FIELD

This disclosure relates to image generation using an artificial intelligence/machine learning (AI/ML) model.

### BACKGROUND

For artificial intelligence (AI)/machine learning (ML) based image generation techniques, a user may provide an image and contextual information about the image. The user may also provide a prompt to modify the image. A neural network model may receive the user provided information and revise the image according to the prompt.

### SUMMARY

In general, this disclosure describes techniques for generating image data. In particular, these techniques may be used in conjunction with a context-aware image generation model for artificial intelligence/machine learning (AI/ML) based image generation. A user may provide an image and a prompt representing a desired set of complex tasks to be performed on the image. Per techniques of this disclosure, a computing device may split the prompt into sub-prompts, corresponding to sub-tasks associated with the set of complex tasks. The computing device may enhance each of the sub-prompts, e.g., to add details, clarify descriptions, or the like. Moreover, the computing device may generate prompt tokens for the sub-prompts, and insert pause tokens between each set of prompt tokens for each of the sub-prompts. The pause tokens may be configured to cause the context-aware image generation model to increase a context for processing the series of prompt tokens, e.g., through increasing a number of attention units in use for processing the series of prompt tokens. In this manner, through increasing the context, the context-aware image generation model may increase a number of decoding steps performed to manipulate the image, using a larger context, which may thereby improve the performance of the context-aware image generation model when performing the image manipulation tasks. Therefore, the resulting manipulated image may better represent the user's intentions for the prompt.

In one example, a method of generating image data includes: receiving an image and a prompt to modify the image, the prompt representing a complex revision task including two or more sub-tasks to be issued to an artificial intelligence/machine learning (AI/ML) model configured to perform in-context image generation; generating sub-prompts from the prompt, each of the sub-prompts corresponding to a sub-task of the two or more sub-tasks; generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and providing the image and the series of prompt tokens to the AI/ML model to cause the AI/ML model to generate a revised image according to the complex revision task.

In another example, a device for generating image data includes: a memory configured to store image data; and a processing system implemented in circuitry and configured to: receive an image and a prompt to modify the image, the prompt representing a complex revision task including two or more sub-tasks to be issued to an artificial intelligence/machine learning (AI/ML) model configured to perform in-context image generation; generate sub-prompts from the prompt, each of the sub-prompts corresponding to a sub-task of the two or more sub-tasks; generate a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and provide the image and the series of prompt tokens to the AI/ML model to cause the AI/ML model to generate a revised image according to the complex revision task.

In another example, a device for generating image data includes: means for receiving an image and a prompt to modify the image, the prompt representing a complex revision task including two or more sub-tasks to be issued to an artificial intelligence/machine learning (AI/ML) model configured to perform in-context image generation; means for generating sub-prompts from the prompt, each of the sub-prompts corresponding to a sub-task of the two or more sub-tasks; means for generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and means for providing the image and the series of prompt tokens to the AI/ML model to cause the AI/ML model to generate a revised image according to the complex revision task.

The details of one or more examples are set forth in the accompanying drawings and the description below. Other features, objects, and advantages will be apparent from the description, drawings, and claims.

### BRIEF DESCRIPTION OF THE DRAWINGS

FIG. 1 is a block diagram illustrating an example image generation system that may perform the techniques of this disclosure.

FIG. 2 is a block diagram illustrating an example set of components of a client device of FIG. 1 in greater detail.

FIG. 3 is a conceptual diagram illustrating an example set of attention units for a standard inference and finetuning process.

FIG. 4 is a conceptual diagram illustrating an example set of attention units for a pause-inference and finetuning process.

FIG. 5 is a conceptual diagram illustrating an example of training a context-aware image generation model with step-by-step processing.

FIG. 6 is a conceptual diagram illustrating another example of training a context-aware image generation model with step-by-step processing.

FIG. 7 is a flowchart illustrating an example method for performing techniques of this disclosure.

### DETAILED DESCRIPTION

In general, this disclosure describes techniques for generating image data. In particular, these techniques may be used in conjunction with a context-aware image generation model for artificial intelligence/machine learning (AI/ML) based image generation. A user may provide an image and a prompt representing a desired set of complex tasks to be performed on the image. Per techniques of this disclosure, a computing device may split the prompt into sub-prompts, corresponding to sub-tasks associated with the set of complex tasks. The computing device may enhance each of the sub-prompts, e.g., to add details, clarify descriptions, or the like. Moreover, the computing device may generate prompt tokens for the sub-prompts, and insert pause tokens between each set of prompt tokens for each of the sub-prompts. The pause tokens may be configured to cause the context-aware image generation model to increase a context (that is, a computational capacity) for processing the series of prompt tokens, e.g., through increasing a number of attention units in use for processing the series of prompt tokens.

In this manner, through increasing the context, the context-aware image generation model may increase a number of decoding steps performed to manipulate the image, using a larger context, which may thereby improve the performance of the context-aware image generation model when performing the image manipulation tasks. Therefore, the resulting manipulated image may better represent the user's intentions for the prompt.

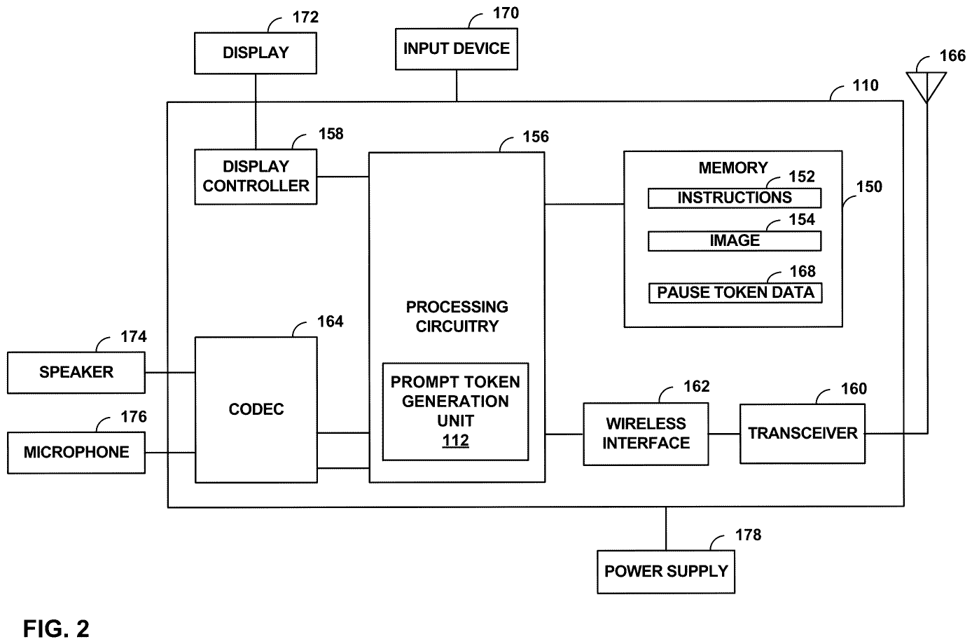

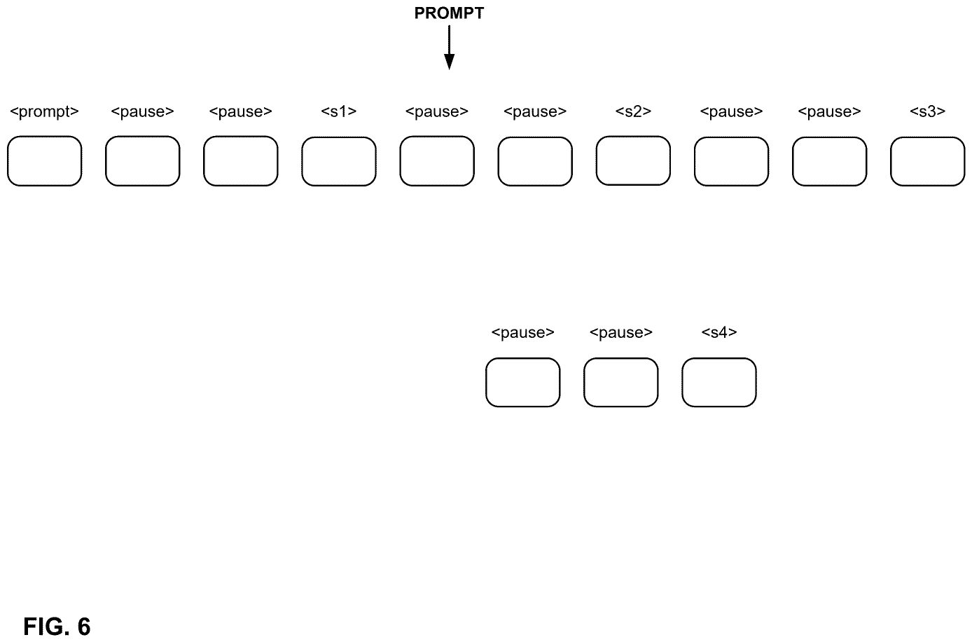

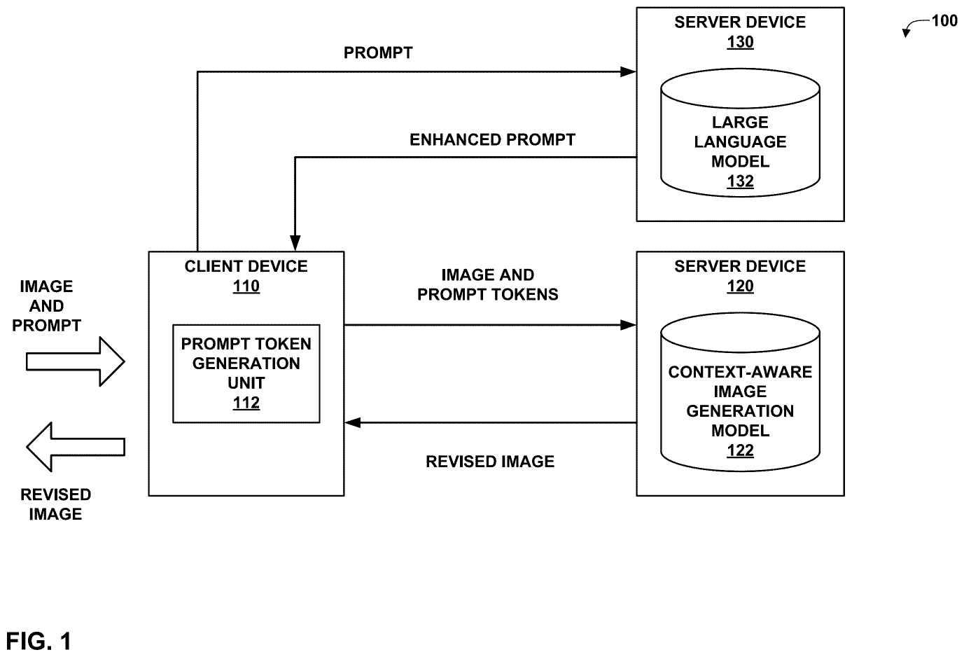

FIG. 1 is a block diagram illustrating an example image generation system 100 that may perform the techniques of this disclosure. As shown in FIG. 1, system 100 includes client device 110, server device 120, and server device 130. Server device 120 hosts context-aware image generation model 122, which may be used to receive one or more images and a text-or token-based prompt to edit the one or more images, and provide an edited image in response. Server device 130 hosts large language model 132, which may be queried with text-based prompts and respond with text-based responses, e.g., in a conversational chat-like format. Client device 110, server device 120, and server device 130 may each represent one or more computing devices communicatively coupled via a computer network, such as the Internet. Client device 110 may be, for example, a desktop computer, a laptop computer, a user equipment (UE) device, a cellular phone, a tablet, or the like. Server devices 120 and 130 may represent one or more server computing devices. Each of client device 110, server device 120, and server device 130 may be configured to implement the functionality attributed to them in hardware, software, or any combination thereof. When implemented in software, requisite hardware (such as a memory to store instructions for the software and processing circuitry configured to execute the instructions) may also be provided.

Large language model 132 may generally be configured (e.g., trained) to process input in the form of natural human language, and to respond with generated human language. Large language model 132 may be trained on a large amount of text data to determine patterns and relationships in language of the text data. Such text data may include any or all of books, magazines, articles, websites, or any other such written content. Large language model 132 may be implemented according to a transformer architecture, that is, a type of neural network configured to process sequential data, such as text data. Large language model 132 may be trained to predict subsequent words in a sequence based on preceding words.

Context-aware image generation model 122 may generally be configured (e.g., trained) to generate one or more output images from one or more input images, descriptions of the input images, and text-based prompts requesting changes to the input images. Rather than requiring full training on a large dataset, context-aware image generation model 122 may be trained to learn from a small set of examples provided at inference time.

Context-aware image generation model 122 may be used in a variety of contexts, e.g., to perform a variety of image generation tasks. For example, context-aware image generation model 122 may be configured to perform object manipulation or transformation in an image, e.g., to add an object to the image, remove an object from the image, replace an object in the image, move an object within the image, resize an object in the image, rotate an object in the image, or duplicate an object in the image. Additionally or alternatively, context-aware image generation model 122 may be configured to perform color or tone adjustments to an image, such as to change colors or to apply a filter or weather effects to the image. Additionally or alternatively, context-aware image generation model 122 may be configured to perform texture or material adjustments to an image, e.g., to modify textures in the image. Additionally or alternatively, context-aware image generation model 122 may be configured to modify the background or environment of an image, e.g., to replace the background. Additionally or alternatively, context-aware image generation model 122 may be configured to perform lighting or shadow adjustments, e.g., to adjust exposure effects in the image (globally, or within particular lighting ranges, such as highlights, midtones, or shadows). Additionally or alternatively, context-aware image generation model 122 may be configured to perform text and symbol modifications to the image, e.g., to add or remove text or change text properties (font, size, position, etc.). Additionally or alternatively, context-aware image generation model 122 may be configured to perform composition or cropping modifications, e.g., to crop an image, to zoom in/out, or to reframe the composition of the image. Additionally or alternatively, context-aware image generation model 122 may be configured to modify model poses or expressions in the image, e.g., to change a pose or to change a facial expression. Additionally or alternatively, context-aware image generation model 122 may be configured to perform special effects, e.g., to remove or add particle effects, and/or to add or remove special effects (e.g., auras or shadows around figures in the image).

Thus, context-aware image generation model 122 may be configured to perform a variety of tasks, such as complex prompt performance, controlled generation (e.g., conditioned on a partial layout), image editing, multi-turn image editing and generation, and/or multi-image editing with text prompts. These tasks may be useful in a variety of situations, such as brand editing, professional photo editing, image stylization, or filters for image or video-based chat applications. Such tasks may be performed for various applications, such as professional designing (e.g., special effects) with applications in camera, visual effects (e.g., real-to-anime), gaming, extended reality (XR) media communication sessions, background replacement, product brand rendering, or the like.

Context-aware image generation model 122 may further, per techniques of this disclosure, be trained to recognize special input tokens referred to herein as “pause tokens.” That is, context-aware image generation model 122 may be trained to pause generation of output images, but to continue updating a key-value (KV) cache, in response to receiving a pause token. Similarly, context-aware image generation model 122 may be trained to continue updating the KV cache in response to two or more consecutive pause tokens, while continuing to refrain from generating output images for the successive pause tokens. In this manner, the pause tokens may represent express indications to stop generating output and to take one or more cycles to update the KV cache. In general, each pause token added to a text-based prompt may increase a number of attention units in use by context-aware image generation model 122. As such, a pause token may be a special token that context-aware image generation model 122 is trained to recognize and, in response, increase a number of decoding steps (e.g., increase attention units, or increase a context/computational capacity).

Client device 110 includes prompt token generation unit 112. Client device 110 includes one or more user interfaces for receiving one or more images from a user along with a prompt from the user to modify the one or more images. The prompt may represent a complex prompt including multiple image editing tasks. In some examples, prompt token generation unit partitions the prompt into two or more sub-prompts, generates tokens from the sub-prompts, and then generates a series of prompt tokens including the tokens from the sub-prompts as well as a number of pause tokens between each set of tokens of the sub-prompts. For example, if the received prompt represents two editing tasks, prompt token generation unit 112 may generate a first sub-prompt and a second sub-prompt, then generate a series of prompt tokens including a first set of prompt tokens for the first sub-prompt, a number of pause tokens, then a second set of prompt tokens for the second sub-prompt.

Prompt token generation unit 112 may receive configuration data representing the number of pause tokens to be inserted between each set of prompt tokens for the sub-prompts. For example, a user may request any integer number of pause tokens to be inserted between sets of prompt tokens. In some examples, one or more predefined numbers of prompt tokens may be configured for prompt token generation unit 112.

In some examples, prompt token generation unit 112 may be configured to generate the sub-prompts and pause tokens. Additionally or alternatively, prompt token generation unit 112 may be configured to provide the received prompt, or some portion thereof and/or data representative of some or all of the received prompt, to server device 130, along with instructions to modify the prompt to generate the sub-prompts using large language model 132. For example, prompt token generation unit 112 may send a natural language instruction to large language model 132, such as, “Here is a prompt to be used to modify an image: <prompt>. Determine sub-tasks involved in fulfilling the prompt, then output a series of sub-prompts for each of the sub-tasks.” In some examples, prompt token generation unit 112 may further provide instructions to generate prompt tokens for the sub-prompts and/or the pause tokens to large language model 132.

In some examples, prompt token generation unit 112 may further be configured to embellish the descriptions of the sub-tasks to improve the image revision process performed by context-aware image generation model 122. That is, prompt token generation unit 112 may be configured to provide extra details for the sub-prompts that may have been implied but not expressly stated in the input prompt. As an example, if prompt token generation unit 112 were to receive an image of flowers and receive a prompt stating, “Have there be a bumblebee near one of the flowers,” prompt token generation unit 112 may separate this prompt into sub-tasks of: <s1>=“Add a bumblebee near one of the yellow roses;” <s2>=“Adjust the bumblebee's size and position;” <s3>=“Enhance the image's colors;” and <s4>=“Refine the background.” Prompt token generation unit 112 may further embellish these sub-prompts to be more descriptive, e.g.: <s1>=“Add a bumblebee near one of the yellow roses: use image editing software to insert a bumblebee image into the scene, positioning it near one of the yellow roses;” <s2>=“Adjust the bumblebee's size and position: refine the bumblebee's size and position to ensure it blends seamlessly with the surrounding flowers and vase;” <s3>=“Enhance the image's colors: apply subtle color adjustments to the image to make the yellow roses and the bumblebee stand out more prominently;” <s4>=“Refine the background: blur the background further to draw more attention to the yellow roses and the bumblebee, creating a sense of depth and focus.”

In some examples, prompt token generation unit 112 may generate and embellish the sub-task prompts directly. Alternatively, prompt token generation unit 112 may be configured to request that large language model 132 generate and/or embellish the sub-prompts for the sub-tasks. For example, prompt token generation unit 112 may generate the sub-prompts from the input prompt, then send each sub-prompt to large language model 132 with instructions to clarify and/or enhance the sub-prompts.

In this manner, prompt token generation unit 112 may be configured to perform scaling of the input prompt through addition of pause tokens and/or expressive prompts. The pause tokens may be used for inference-only or for training-time finetuning. The use of the pause tokens may increase a capacity with respect to a total number of KV-Cache-based updates and improve attention-based aggregation. The pause tokens may add different attention units to the model and allow in-context inference time scaling. In this manner, context-aware image generation model 122 may receive richer feedback at training time, which may improve grounding by learning fine-grained vision-language dependencies as expressive prompts are used training time. Therefore, context-aware image generation model 122 may improve small, granular details using the pause tokens and resultant increased capacity during the image modification and generation process.

Ultimately, prompt token generation unit 112 and client device 110 may send the received image and the series of prompt tokens (for each sub-prompt, separated by pause tokens) to server device 120. This may cause context-aware image generation model 122 to process the image according to the series of prompt tokens, including increasing context of processing the image according to the pause tokens, and to then return a processed image to client device 110. Client device 110 may then present the processed image to the user.

Increasing the context (e.g., adding additional attention units) through the use of pause tokens may improve the image manipulation and generation process performed by context-aware image generation model 122. Thus, the techniques of this disclosure may cause server device 120 to perform image manipulation and generation in a way that better represents the input prompt. Therefore, these techniques may improve performance related to AI/ML-based image manipulation and generation.

Client device 110 may include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, client device 110 may be equipped for wireless communication, and thus may be referred to as a wireless communication device.

In some examples, client device 110 may output the processed image to a storage device. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data.

Client device 110 and server devices 120, 130 may include network interfaces such as wireless transmitters/receivers, modems, wired networking components (e.g., Ethernet cards), wireless communication components that operate according to any of a variety of IEEE 802.11 standards, or other physical components. In examples where client device 110 and server devices 120, 130 include wireless components, network interfaces of client device 110 and server devices 120, 130 may be configured to transfer data, such as encoded image data, according to a cellular communication standard, such as 4G, 4G-LTE (Long-Term Evolution), LTE Advanced, 5G, or the like. In some examples where client device 110 includes a wireless transmitter, client device 110 and server devices 120, 130 may be configured to transfer data, such as encoded image data, according to other wireless standards, such as an IEEE 802.11 specification, an IEEE 802.15 specification (e.g., ZigBee™), a Bluetooth™ standard, or the like. In some examples, client device 110 and server devices 120, 130 may include respective system-on-a-chip (SoC) devices. For example, client device 110 may include an SoC device to perform the functionality attributed to prompt token generation unit 112, and server devices 120, 130 may include respective SoC devices to perform the functionality attributed to large language model 132 and context-aware image generation model 122.

Prompt token generation unit 112 may be implemented as any of a variety of suitable circuitry of a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

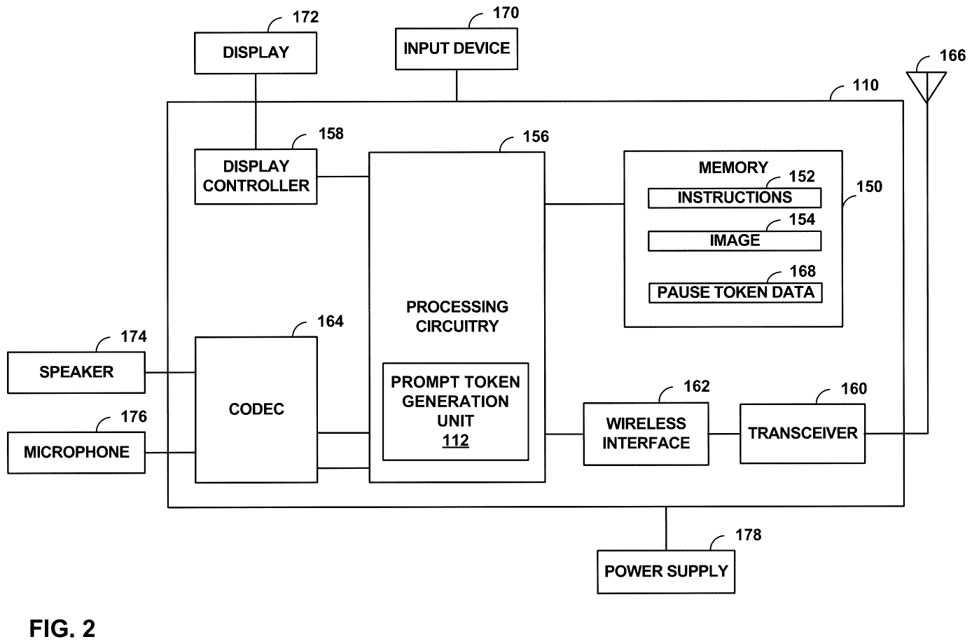

FIG. 2 is a block diagram illustrating an example set of components of client device 110 of FIG. 1 in greater detail. FIG. 2 is provided for purposes of explanation and should not be considered limiting of the techniques as broadly exemplified and described in this disclosure.

In the example of FIG. 2, client device 110 includes memory 150, processing circuitry 156, display controller 158, transceiver 160, wireless interface 162, antenna 166, and encoder/decoder (CODEC) 164. Any or all of these various components may be implemented in one or more processors or in processing circuitry. For instance, the units of client device 110 may be implemented as one or more circuits or logic elements as part of hardware circuitry, or as part of a processor, ASIC, or FPGA. Moreover, client device 110 may include additional or alternative processors or processing circuitry to perform these and other functions.

In this example, memory 150 includes instructions 152 (e.g., executable instructions) such as computer-readable instructions or processor-readable instructions. The instructions 152 may include one or more instructions that are executable by a computer, such as processing circuitry 156.

In this example, processing circuitry 156 further includes prompt token generation unit 112. For example, prompt token generation unit 112 may be a fully hardware-based unit. Alternatively, instructions for prompt token generation unit 112 may be stored in memory 150 among instructions 152 and executed by processing circuitry 156. In either case, prompt token generation unit 112 may perform any of the various techniques of this disclosure, e.g., of receiving an image

[symbol]

Client device 110 may include display controller 158 that is coupled to the processing circuitry 156 and to a display 172. A coder/decoder (CODEC) 164 may also be coupled to the processing circuitry 156. A speaker 174 and a microphone 176 may be coupled to the CODEC 164.

FIG. 2 also illustrates that a wireless interface 162, such as a wireless controller, and a transceiver 160 may be coupled to the processing circuitry 156 and to an antenna 166, such that wireless data received via the antenna 166, the transceiver 160, and the wireless interface 162 may be provided to the processing circuitry 156. In some examples, processing circuitry 156, display controller 158, memory 150, CODEC 164, wireless interface 162, and transceiver 160 are included in a system-in-package or system-on-chip device. In some examples, input device 170 and power supply 178 are coupled to the system-on-chip device. Moreover, in some examples, display 172, input device 170, speaker 174, microphone 176, antenna 166, and power supply 178 are external to the system-on-chip device. In some examples, each of display 172, input device 170, speaker 174, microphone 176, antenna 166, and power supply 178 may be coupled to a component of the system-on-chip device, such as an interface or a controller.

In some examples, memory 150 includes or stores instructions 152 (e.g., executable instructions), such as computer-readable instructions or processor-readable instructions. For example, memory 150 may include or correspond to a non-transitory, computer readable medium storing the instructions 152. Instructions 152 may include one or more instructions that are executable by a computer, such as the processing circuitry 156. In some examples, client device 110 includes a non-transitory, computer readable medium (e.g., memory 150) storing instructions (e.g., instructions 152) that, when executed by a processing system including one more processors (e.g., processing circuitry 156), may cause the processing system to perform operations described in this disclosure.

Various functions performed by the components of client device 110 are described with reference to certain components or circuitry. This division of components and circuitry is for illustration only. In an alternate aspect, a function performed by a particular component may be divided amongst multiple components. Moreover, in an alternate aspect, two or more components described with reference to FIG. 2 may be integrated into a single component. Each component described with reference to FIG. 2 may be implemented using hardware (e.g., a field-programmable gate array (FPGA) device, an application-specific integrated circuit (ASIC), a DSP, a controller, etc.), software (e.g., instructions executable by a processor), or any combination thereof.

One or more of the techniques of this disclosure may be implemented in a system or an apparatus, such as client device 110, that may include a communications device, a fixed location data unit, a mobile location data unit, a mobile phone, a cellular phone, a satellite phone, a computer, a tablet, a portable computer, a display device, a media player, or a desktop computer. Additionally or alternatively, client device 110 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, a component integrated within a vehicle, any other device that includes a processor or that stores or retrieves data or computer instructions, or a combination thereof. As another illustrative, non-limiting example, client device 110 may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

As discussed above, per techniques of this disclosure, client device 110 may receive an image and a prompt from a user. In some examples, client device 110 may include a camera that captures the image. Alternatively, the image may already be stored in memory 150 as image 154. When not previously stored in memory 150, in response to receiving or capturing the image, processing circuitry 156 may store the image to memory 150 as image 154. Client device 110 may also receive a prompt for editing the image from a user, e.g., via input device 170 (which may be a keyboard, touchscreen, or the like) or via microphone 176 as an audio prompt. In the case of an audio prompt, client device 110 may be configured to transcribe the audio prompt into a text-based prompt.

Prompt token generation unit 112 may receive a prompt for processing image 154. Per techniques of this disclosure, prompt token generation unit 112 may be configured to process the prompt to determine two or more processing tasks associated with the prompt and to be applied to image 154. Prompt token generation unit 112 may then generate sub-prompts corresponding to the two or more processing tasks, as well as prompt tokens for each of the sub-prompts. Prompt token generation unit 112 may further determine a representation of a pause token and a number of pause tokens to be inserted between sets of prompt tokens from pause token data 168. Pause token data 168 may define a tokenized representation of a pause token, as well as the number of pause tokens to be inserted. In this manner, pause token data 168 represents pause token configuration data for client device 110.

As discussed above, prompt token generation unit 112 may also enhance the sub-prompts associated with the sub-tasks. For example, prompt token generation unit 112 may add additional descriptive text to any or all of the sub-prompts to make the sub-prompts more specific and complete.

In some examples, prompt token generation unit 112 may send the received prompt along with instructions to split the prompt into sub-prompts and/or to enhance the sub-prompts for additional clarity or specificity to large language model 132 (FIG. 1). For example, prompt token generation unit 112 may output the prompt and instructions for modifying the prompt via wireless interface 162, transceiver 160, and antenna 166 to, e.g., a base station (e.g., a gNodeB) of a radio access network (RAN), to cause the base station to forward the prompt and instructions for modifying the prompt to large language model 132.

After having formed a series of prompt tokens including prompt tokens for the sub-prompts separated by a number of pause tokens, prompt token generation unit 112 may send the series of prompt tokens and image 154 to context-aware image generation model 122 (FIG. 1), e.g., via the base station. Client device 110 may then receive, from context-aware image generation model 122, a revised image according to the series of prompt tokens. Client device 110 may present the revised image to a user via display controller 158 and display 172.

In this manner, client device 110 represents an example of a device for generating image data, including a memory configured to store image data; and a processing system implemented in circuitry and configured to: receive an image and a prompt to modify the image, the prompt representing a complex revision task including two or more sub-tasks to be issued to an artificial intelligence/machine learning (AI/ML) model configured to perform in-context image generation; generate sub-prompts from the prompt, each of the sub-prompts corresponding to a sub-task of the two or more sub-tasks; generate a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a context (computational capacity) when performing the complex revision task; and provide the image and the series of prompt tokens to the AI/ML model to cause the AI/ML model to generate a revised image according to the complex revision task.

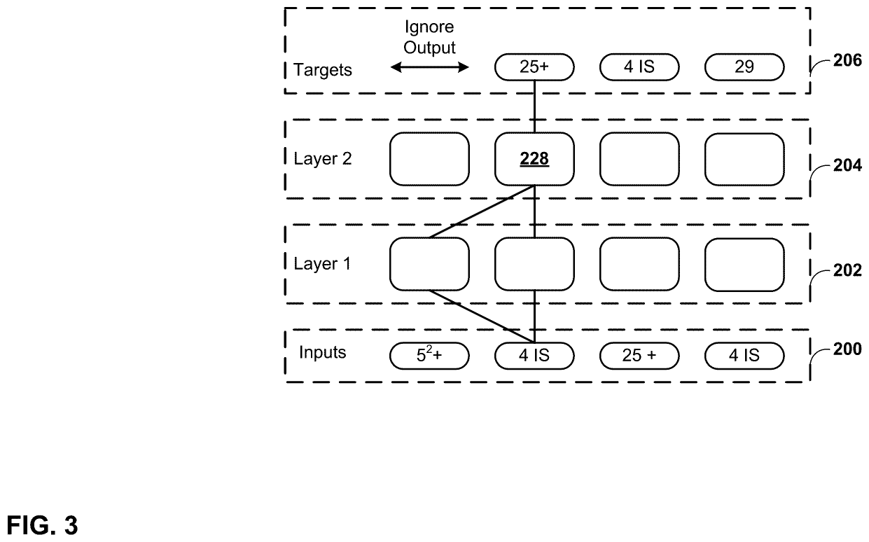

FIG. 3 is a conceptual diagram illustrating an example set of attention units for a standard inference and finetuning process. In this example, input tokens 200 include a “5²+” token, a “4 is” token, a “25+” token, and a “4 is” token. The input tokens are received and processed by layer 1 attention units 202. Outputs of layer 1 attention units are processed by layer 2 attention units 204. Then layer 2 attention units generate output tokens 206. In particular, based on processing of the “5²+” and “4 is” tokens, output node 228 of layer 2 attention units 204 outputs “25+.”

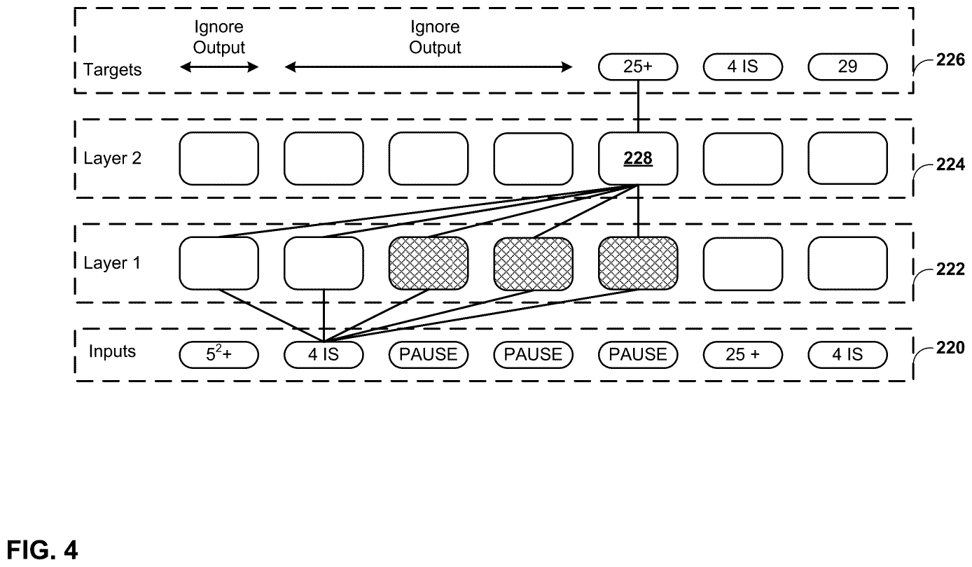

FIG. 4 is a conceptual diagram illustrating an example set of attention units for a pause-inference and finetuning process. In this example, input tokens 220 include a “5²+” token, a “4=” token, a “25+” token, and a “4 is” token, similar to input tokens 200 of FIG. 3. However, in addition, input tokens 220 include three “PAUSE” tokens. The three example “PAUSE” tokens as shown in FIG. 4 cause layer 1 attention units 222 of FIG. 4 to include three additional attention units, relative to the example of layer 1 attention units 202 of FIG. 3. In this manner, node 228 can process outputs of five attention units of layer 1 attention units 222. In this manner, the “PAUSE” tokens increase a number of decoding steps, and a context, for generating output at node 228, relative to the example of FIG. 3.

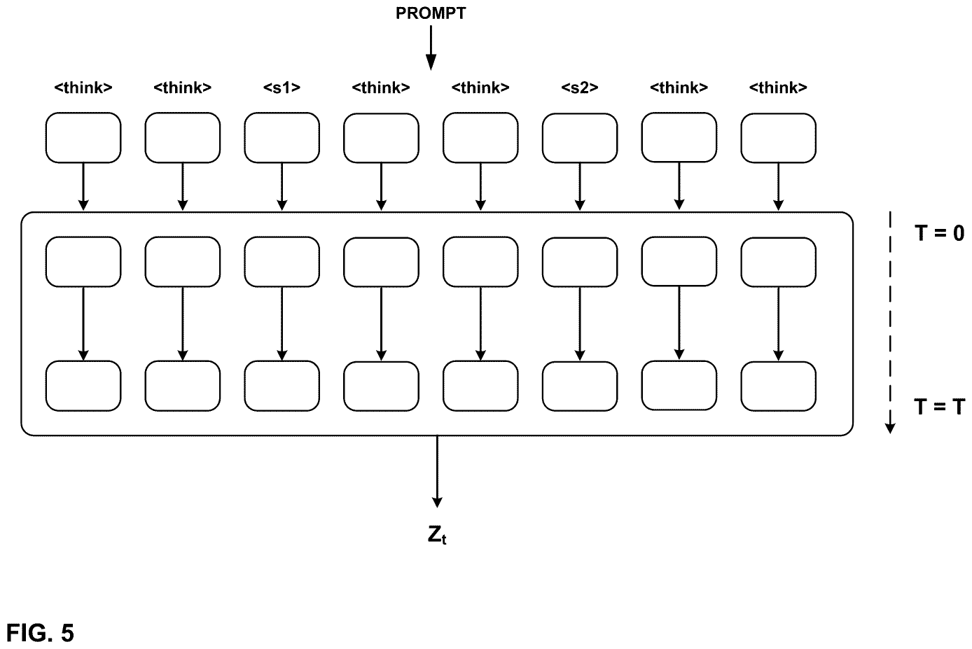

FIG. 5 is a conceptual diagram illustrating an example of training a context-aware image generation model with step-by-step processing. In this example, a prompt is separated into sub-prompts <s1> and <s2> with intervening pause tokens (“<think>” tokens in the example of FIG. 5) between each set of sub-prompts. In this example, the context-aware image generation model may be trained using outcome rewards and no step level verification, which may lead to richer instruction tuning.

During a reverse diffusion process (that is, generation): t=0 signifies the first denoising step, initiating the process from an initial noisy state. t=T_{final} (where T_{final} is the index of the last step) signifies the final denoising step, which yields the fully generated image. Zt denotes the intermediate prediction or image state at denoising step t (where 0≤t≤T_{final}) within this multi-step generation.

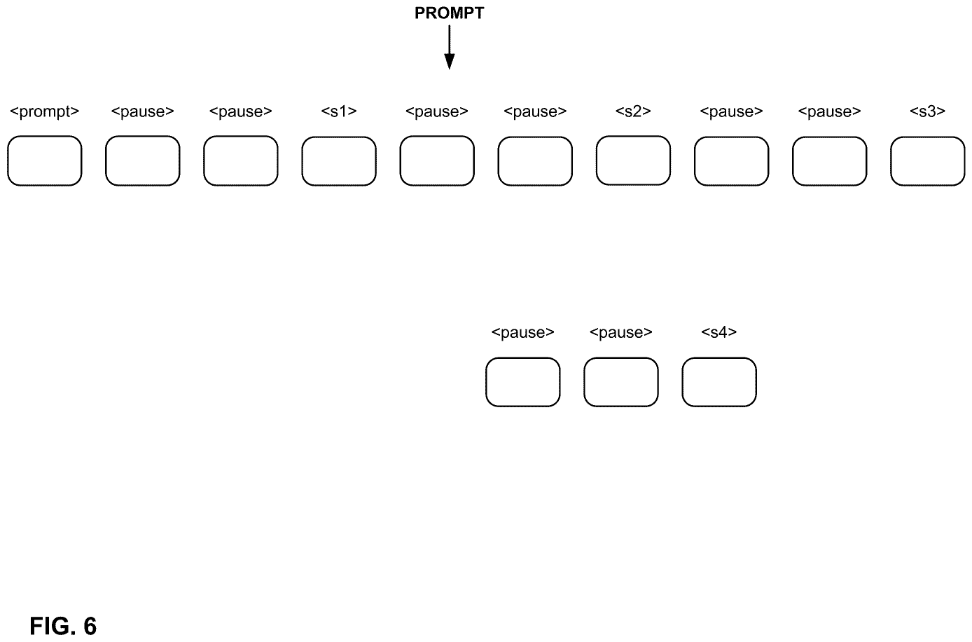

FIG. 6 is a conceptual diagram illustrating another example of training a context-aware image generation model with step-by-step processing. In this example, again a prompt is separated into sub-prompts, each corresponding to a respective set of sub-prompt tokens separated by a number of pause tokens. For example, the prompt may be “have there be a bumblebee near one of the flowers.” This prompt may be separated into four sub-tasks, <s1> to <s4>. <s1> may be, “Add a bumblebee near one of the yellow roses: use image editing software to insert a bumblebee image into the scene, positioning it near one of the yellow roses.” <s2> may be, “Adjust the bumblebee's size and position: refine the bumblebee's size and position to ensure it blends seamlessly with the surrounding flowers and vase.” <s3> may be, “Enhance the image's colors: apply subtle color adjustments to the image to make the yellow roses and the bumblebee stand out more prominently.” <s4> may be, “Refine the background: blur the background further to draw more attention to the yellow roses and the bumblebee, creating a sense of depth and focus.”

In this manner, the techniques of this disclosure include in-context inference time scaling for image generation and/or editing. These techniques may use an inference time only approach to improve quality without retraining or changing the image-generation model. These techniques may involve dynamic inference-time computation for image generation and/or editing. Training time finetuning may be used to further improve performance. These techniques may also include expressive prompting-based finetuning to improve grounding and boost inference time scaling through improved grounding and capacity of the base model.

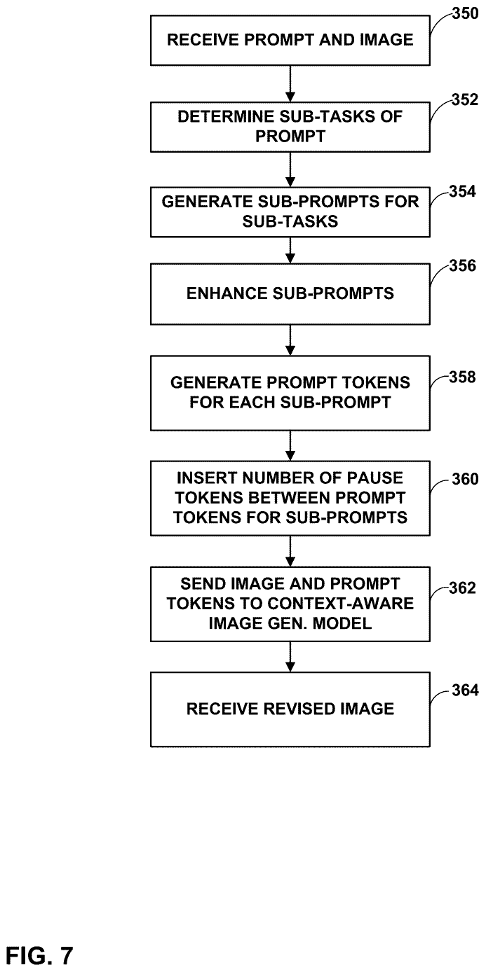

FIG. 7 is a flowchart illustrating an example method for performing techniques of this disclosure. The method of FIG. 7 is described with respect to client device 110 of FIGS. 1 and 2. Other devices may perform this or a similar method.

Initially, client device 110 receives an image and a prompt to edit the image (350). For example, a user may load a stored image, capture a new image, upload a new image, or the like. The user may also provide the prompt via a user interface, such as a keyboard, touchscreen, microphone, or the like.

Client device 110 may then determine sub-tasks of a complex task corresponding to the prompt (352). Client device 110 may also generate sub-prompts for the sub-tasks (354). For example, client device 110 may be configured to analyze the prompt to determine discrete steps that can be performed in order to satisfy the prompt. Additionally or alternatively, client device 110 may send the prompt to a large language model, such as large language model 132, along with instructions to generate sub-prompts associated with the sub-tasks.

Moreover, client device 110 may enhance the sub-prompts (356). For example, for each sub-prompt, client device 110 may add additional descriptions for the sub-tasks represented by the sub-prompt to increase clarity and descriptiveness of the sub-prompts. In some examples, client device 110 may provide instructions to a large language model, such as large language model 132, to enhance the sub-prompts in this manner, e.g., when the prompt is sent to the large language model for generation of the sub-prompts.

Client device 110 may further generate prompt tokens for each of the sub-prompts (358). For example, a prompt token may represent a number of characters, e.g., four characters, of the sub-prompt. Thus, client device 110 may generate sets of prompt tokens for each of the sub-prompts. Furthermore, client device 110 may insert a number of pause tokens between each set of prompt tokens for the sub-prompts (360). Client device 110 may determine the number of pause tokens to be inserted based on configuration data, instructions from the user, or the like. Ultimately, the full set of prompt tokens and intervening pause tokens may represent a full series of prompt tokens for the original prompt.

Client device 110 may then send the image and the series of prompt tokens to a context-aware image generation model, such as context-aware image generation model 122 of FIG. 1 (362). The pause tokens may cause the context-aware image generation model to increase a context (computational capacity) for processing the prompt tokens when manipulating the image, e.g., through increasing a number of attention units. In this manner, the pause tokens may cause the context-aware image generation model to better manipulate the image in line with the original prompt. Ultimately, client device 110 may receive a revised image, that is, a revised version of the image that has been manipulated according to the series of prompt tokens (364).

In this manner, the method of FIG. 7 represents an example of a method of generating image data, including: receiving an image and a prompt to modify the image, the prompt representing a complex revision task including two or more sub-tasks to be issued to an artificial intelligence/machine learning (AI/ML) model configured to perform in-context image generation; generating sub-prompts from the prompt, each of the sub-prompts corresponding to a sub-task of the two or more sub-tasks; generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and providing the image and the series of prompt tokens to the AI/ML model to cause the AI/ML model to generate a revised image according to the complex revision task.

The following clauses represent various examples of the techniques of this disclosure:

Clause 1: A method of generating image data, the method comprising: receiving an image and a prompt to modify the image, the prompt representing a complex revision task including two or more sub-tasks to be issued to an artificial intelligence/machine learning (AI/ML) model configured to perform in-context image generation; generating sub-prompts from the prompt, each of the sub-prompts corresponding to a sub-task of the two or more sub-tasks; generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a context when performing the complex revision task; and providing the image and the series of prompt tokens to the AI/ML model to cause the AI/ML model to generate a revised image according to the complex revision task.

Clause 2: The method of clause 1, wherein generating the series of prompt tokens comprises determining the number of pause tokens according to configuration data.

Clause 3: The method of clause 2, further comprising receiving the configuration data defining the number of pause tokens.

Clause 4: The method of any of clauses 1-3, wherein generating the sub-prompts comprises, for at least one of the sub-tasks: determining two or more steps for performing the at least one of the sub-tasks that are not explicitly described in the prompt; and generating the sub-prompt for the at least one of the sub-tasks to include descriptions of each of the two or more steps.

Clause 5: The method of any of clauses 1-4, wherein the pause tokens comprise tokens configured to cause the AI/ML model to stop generating output until a subsequent non-pause token of the series of prompt tokens, but to continue to update a key-value (KV) cache.

Clause 6: The method of any of clauses 1-5, wherein the pause tokens comprise tokens configured to cause the AI/ML model to increase a number of decoding steps.

Clause 7: The method of any of clauses 1-6, wherein the pause tokens comprise tokens configured to cause the AI/ML model to increase a number of attention units.

Clause 8: The method of any of clauses 1-7, wherein the prompt comprises an input prompt, and wherein generating sub-prompts from the input prompt comprises providing the input prompt to a second AI/ML model comprising a large language model (LLM) with a task prompt including instructions for the LLM to split the input prompt into the sub-prompts.

Clause 9: The method of clause 8, wherein generating the series of prompt tokens comprises generating the task prompt to include instructions for the LLM to generate the number of pause tokens between the sub-series of prompts.

Clause 10: The method of any of clauses 8 and 9, wherein generating the sub-prompts comprises generating the task prompt to include instructions for the LLM to further describe the sub-tasks in the corresponding sub-prompts.

Clause 11: A device for generating image data, the device comprising one or more means for performing the method of any of clauses 1-10.

Clause 12: The device of clause 11, further comprising a display configured to display the image data.

Clause 13: The device of any of clauses 11 and 12, wherein the device comprises one or more of a camera, a computer, a mobile device, a broadcast receiver device, or a set-top box.

Clause 14: The device of any of clauses 11-13, further comprising a memory configured to store the image data.

Clause 15: A computer-readable storage medium having stored thereon instructions that, when executed, cause a processor of a device for generating image data to perform the method of any of clauses 1-10.

Clause 16: A device for generating image data, the device comprising: a memory configured to store image data; and a processing system implemented in circuitry and configured to: receive an image and a prompt to modify the image, the prompt representing a complex revision task including two or more sub-tasks to be issued to an artificial intelligence/machine learning (AI/ML) model configured to perform in-context image generation; generate sub-prompts from the prompt, each of the sub-prompts corresponding to a sub-task of the two or more sub-tasks; generate a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a context when performing the complex revision task; and provide the image and the series of prompt tokens to the AI/ML model to cause the AI/ML model to generate a revised image according to the complex revision task.

Clause 17: The device of clause 16, wherein to generate the series of prompt tokens, the processing system is configured to determine the number of pause tokens according to configuration data.

Clause 18: The device of clause 17, wherein the processing system is further configured to receive the configuration data defining the number of pause tokens.

Clause 19: The device of any of clauses 16-18, wherein to generate the sub-prompts, the processing system is configured to, for at least one of the sub-tasks: determine two or more steps for performing the at least one of the sub-tasks that are not explicitly described in the prompt; and generate the sub-prompt for the at least one of the sub-tasks to include descriptions of each of the two or more steps.

Clause 20: The device of any of clauses 16-19, wherein the pause tokens comprise tokens configured to cause the AI/ML model to stop generating output until a subsequent non-pause token of the series of prompt tokens, but to continue to update a key-value (KV) cache.

Clause 21: The device of any of clauses 16-20, wherein the pause tokens comprise tokens configured to cause the AI/ML model to increase a number of decoding steps.

Clause 22: The device of any of clauses 16-21, wherein the pause tokens comprise tokens configured to cause the AI/ML model to increase a number of attention units.

Clause 23: The device of any of clauses 16-22, wherein the prompt comprises an input prompt, and wherein to generate the sub-prompts from the input prompt, the processing system is configured to provide the input prompt to a second AI/ML model comprising a large language model (LLM) with a task prompt including instructions for the LLM to split the input prompt into the sub-prompts.

Clause 24: The device of clause 23, wherein to generate the series of prompt tokens, the processing system is configured to generate the task prompt to include instructions for the LLM to generate the number of pause tokens between the sub-series of prompts.

Clause 25: The device of any of clauses 23 and 24, wherein to generate the sub-prompts, the processing system is configured to generate the task prompt to include instructions for the LLM to further describe the sub-tasks in the corresponding sub-prompts.

Clause 26: A device for generating image data, the device comprising: means for receiving an image and a prompt to modify the image, the prompt representing a complex revision task including two or more sub-tasks to be issued to an artificial intelligence/machine learning (AI/ML) model configured to perform in-context image generation; means for generating sub-prompts from the prompt, each of the sub-prompts corresponding to a sub-task of the two or more sub-tasks; means for generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a context when performing the complex revision task; and means for providing the image and the series of prompt tokens to the AI/ML model to cause the AI/ML model to generate a revised image according to the complex revision task.

Clause 27: A method of generating image data, the method comprising: receiving an image and a prompt to modify the image, the prompt representing a complex revision task including two or more sub-tasks to be issued to an artificial intelligence/machine learning (AI/ML) model configured to perform in-context image generation; generating sub-prompts from the prompt, each of the sub-prompts corresponding to a sub-task of the two or more sub-tasks; generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and providing the image and the series of prompt tokens to the AI/ML model to cause the AI/ML model to generate a revised image according to the complex revision task.

Clause 28: The method of clause 27, wherein generating the series of prompt tokens comprises determining the number of pause tokens according to configuration data.

Clause 29: The method of clause 28, further comprising receiving the configuration data defining the number of pause tokens.

Clause 30: The method of clause 27, wherein generating the sub-prompts comprises, for at least one of the sub-tasks: determining two or more steps for performing the at least one of the sub-tasks that are not explicitly described in the prompt; and generating the sub-prompt for the at least one of the sub-tasks to include descriptions of each of the two or more steps.

Clause 31: The method of clause 27, wherein the pause tokens comprise tokens configured to cause the AI/ML model to stop generating output until a subsequent non-pause token of the series of prompt tokens, but to continue to update a key-value (KV) cache and to iteratively refine predictions before final prediction or generation.

Clause 32: The method of clause 27, wherein the pause tokens comprise tokens configured to cause the AI/ML model to increase a context of model input before a decoding stage.

Clause 33: The method of clause 27, wherein the pause tokens comprise tokens configured to cause the AI/ML model to increase a number of attention units.

Clause 34: The method of clause 27, wherein the prompt comprises an input prompt, and wherein generating sub-prompts from the input prompt comprises providing the input prompt to a second AI/ML model comprising a large language model (LLM) with a task prompt including instructions for the LLM to split the input prompt into the sub-prompts.

Clause 35: The method of clause 34, wherein generating the series of prompt tokens comprises generating the task prompt to include instructions for the LLM to generate the number of pause tokens between the sub-series of prompts.

Clause 36: The method of clause 34, wherein generating the sub-prompts comprises generating the task prompt to include instructions for the LLM to further describe the sub-tasks in the corresponding sub-prompts.

Clause 37: A device for generating image data, the device comprising: a memory configured to store image data; and a processing system implemented in circuitry and configured to: receive an image and a prompt to modify the image, the prompt representing a complex revision task including two or more sub-tasks to be issued to an artificial intelligence/machine learning (AI/ML) model configured to perform in-context image generation; generate sub-prompts from the prompt, each of the sub-prompts corresponding to a sub-task of the two or more sub-tasks; generate a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and provide the image and the series of prompt tokens to the AI/ML model to cause the AI/ML model to generate a revised image according to the complex revision task.

Clause 38: The device of clause 37, wherein to generate the series of prompt tokens, the processing system is configured to determine the number of pause tokens according to configuration data.

Clause 39: The device of clause 38, wherein the processing system is further configured to receive the configuration data defining the number of pause tokens.

Clause 40: The device of clause 37, wherein to generate the sub-prompts, the processing system is configured to, for at least one of the sub-tasks: determine two or more steps for performing the at least one of the sub-tasks that are not explicitly described in the prompt; and generate the sub-prompt for the at least one of the sub-tasks to include descriptions of each of the two or more steps.

Clause 41: The device of clause 37, wherein the pause tokens comprise tokens configured to cause the AI/ML model to stop generating output until a subsequent non-pause token of the series of prompt tokens, but to continue to update a key-value (KV) cache and to iteratively refine predictions before final prediction or generation.

Clause 42: The device of clause 37, wherein the pause tokens comprise tokens configured to cause the AI/ML model to increase a context for model input before a decoding stage.

Clause 43: The device of clause 37, wherein the pause tokens comprise tokens configured to cause the AI/ML model to increase a number of attention units.

Clause 44: The device of clause 37, wherein the prompt comprises an input prompt, and wherein to generate the sub-prompts from the input prompt, the processing system is configured to provide the input prompt to a second AI/ML model comprising a large language model (LLM) with a task prompt including instructions for the LLM to split the input prompt into the sub-prompts.

Clause 45: The device of clause 44, wherein to generate the series of prompt tokens, the processing system is configured to generate the task prompt to include instructions for the LLM to generate the number of pause tokens between the sub-series of prompts.

Clause 46: The device of clause 44, wherein to generate the sub-prompts, the processing system is configured to generate the task prompt to include instructions for the LLM to further describe the sub-tasks in the corresponding sub-prompts.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of generating image data, the method comprising:
receiving an image and a prompt to modify the image, the prompt representing a complex revision task including two or more sub-tasks to be issued to an artificial intelligence/machine learning (AI/ML) model configured to perform in-context image generation;
generating sub-prompts from the prompt, each of the sub-prompts corresponding to a sub-task of the two or more sub-tasks;
generating a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and
providing the image and the series of prompt tokens to the AI/ML model to cause the AI/ML model to generate a revised image according to the complex revision task.

2. The method of claim 1, wherein generating the series of prompt tokens comprises determining the number of pause tokens according to configuration data.

3. The method of claim 2, further comprising receiving the configuration data defining the number of pause tokens.

4. The method of claim 1, wherein generating the sub-prompts comprises, for at least one of the sub-tasks:
determining two or more steps for performing the at least one of the sub-tasks that are not explicitly described in the prompt; and
generating the sub-prompt for the at least one of the sub-tasks to include descriptions of each of the two or more steps.

5. The method of claim 1, wherein the pause tokens comprise tokens configured to cause the AI/ML model to stop generating output until a subsequent non-pause token of the series of prompt tokens, but to continue to update a key-value (KV) cache and to iteratively refine predictions before final prediction or generation.

6. The method of claim 1, wherein the pause tokens comprise tokens configured to cause the AI/ML model to increase the computational capacity of model input before a decoding stage.

7. The method of claim 1, wherein the pause tokens comprise tokens configured to cause the AI/ML model to increase a number of attention units.

8. The method of claim 1, wherein the prompt comprises an input prompt, and wherein generating sub-prompts from the input prompt comprises providing the input prompt to a second AI/ML model comprising a large language model (LLM) with a task prompt including instructions for the LLM to split the input prompt into the sub-prompts.

9. The method of claim 8, wherein generating the series of prompt tokens comprises generating the task prompt to include instructions for the LLM to generate the number of pause tokens between the sub-series of prompts.

10. The method of claim 8, wherein generating the sub-prompts comprises generating the task prompt to include instructions for the LLM to further describe the sub-tasks in the corresponding sub-prompts.

11. A device for generating image data, the device comprising:
a memory configured to store image data; and
a processing system implemented in circuitry and configured to:
receive an image and a prompt to modify the image, the prompt representing a complex revision task including two or more sub-tasks to be issued to an artificial intelligence/machine learning (AI/ML) model configured to perform in-context image generation;
generate sub-prompts from the prompt, each of the sub-prompts corresponding to a sub-task of the two or more sub-tasks;
generate a series of prompt tokens including respective sub-series of prompt tokens for each of the sub-prompts, each of the sub-series of prompts being separated by a number of pause tokens in the series of prompt tokens, the pause tokens comprising tokens configured to cause the AI/ML model to increase a computational capacity when performing the complex revision task; and
provide the image and the series of prompt tokens to the AI/ML model to cause the AI/ML model to generate a revised image according to the complex revision task.

12. The device of claim 11, wherein to generate the series of prompt tokens, the processing system is configured to determine the number of pause tokens according to configuration data.

13. The device of claim 12, wherein the processing system is further configured to receive the configuration data defining the number of pause tokens.

14. The device of claim 11, wherein to generate the sub-prompts, the processing system is configured to, for at least one of the sub-tasks:
determine two or more steps for performing the at least one of the sub-tasks that are not explicitly described in the prompt; and
generate the sub-prompt for the at least one of the sub-tasks to include descriptions of each of the two or more steps.

15. The device of claim 11, wherein the pause tokens comprise tokens configured to cause the AI/ML model to stop generating output until a subsequent non-pause token of the series of prompt tokens, but to continue to update a key-value (KV) cache and to iteratively refine predictions before final prediction or generation.

16. The device of claim 11, wherein the pause tokens comprise tokens configured to cause the AI/ML model to increase the computational capacity for model input before a decoding stage.

17. The device of claim 11, wherein the pause tokens comprise tokens configured to cause the AI/ML model to increase a number of attention units.

18. The device of claim 11, wherein the prompt comprises an input prompt, and wherein to generate the sub-prompts from the input prompt, the processing system is configured to provide the input prompt to a second AI/ML model comprising a large language model (LLM) with a task prompt including instructions for the LLM to split the input prompt into the sub-prompts.

19. The device of claim 18, wherein to generate the series of prompt tokens, the processing system is configured to generate the task prompt to include instructions for the LLM to generate the number of pause tokens between the sub-series of prompts.

20. The device of claim 18, wherein to generate the sub-prompts, the processing system is configured to generate the task prompt to include instructions for the LLM to further describe the sub-tasks in the corresponding sub-prompts.
